(19) United States
(12) Patent Application Publication
(10) Pub. No.: US 2016/0097722 A1
(43) Pub. Date: Apr. 7, 2016

(54) PLASMA DIAGNOSTIC METHOD AND APPARATUS USING RAMAN SCATTERING

(71) Applicant: UNIST Academy-Industry Research Corporation, Ulsan (KR)

(72) Inventors: Min Sup HUR, Ulsan (KR); Young Kuk KIM, Busan (KR); Myung Hoon JO, Ulsan (KR)

(21) Appl. No.: 14/684,178

(22) Filed: Apr. 10, 2015

(30) Foreign Application Priority Data
Oct. 7, 2014 (KR) 10-2014-0134834

(51) Int. Cl. G01N 21/65

(52) U.S. Cl. CPC G01N 21/65; G01N 2201/06113

(57) ABSTRACT

A plasma diagnostic method and apparatus using Raman scattering are disclosed herein. The plasma diagnostic method using Raman scattering includes focusing a laser beam, controlled such that the laser beam enters a preset polarized state, into a gas within a vacuum chamber, generating plasma in response to the focusing of the laser beam, magnetizing the generated plasma by inducing an electromagnetic field using a radio frequency (RF) power source mounted on the vacuum chamber and configured to provide an RF signal, and performing plasma diagnostic parameter-based monitoring based on scattered light generated via the laser beam incident into the magnetized plasma.

### CROSS-REFERENCE TO RELATED APPLICATION

This application claims the priority based on Korean Application No. 10-2014-0134834 filed Oct. 7, 2014, which is incorporated herein by reference.

### BACKGROUND

1. Technical Field

The present disclosure relates to the diagnosis of plasma.

2. Description of the Related Art

In general, Faraday rotation has been used as magnetized plasma diagnostics.

In connection with this, Korean Patent Application Publication No. 10-2006-0081808 discloses a Faraday system for measuring the current of an ion beam, which radiates an ion beam, extracted from a plasma source, into insulated segment areas and then measures the current of each of the areas.

However, the plasma diagnostics using Faraday rotation has a limitation on increasing sensitivity depending on the size of corresponding plasma and the refractive index of plasma. Therefor, there is a need for technology that is capable of monitoring plasma with high sensitivity in a plasma process.

### SUMMARY

At least one embodiment of the present disclosure is directed to the provision of technology that is capable of monitoring plasma diagnostic parameters, such as the density and magnetic field of magnetized plasma, using Raman scattering that is generated by interaction between a laser beam and plasma.

In accordance with an aspect of the present disclosure, there is provided a plasma diagnostic method using Raman scattering, including focusing a laser beam, controlled such that the laser beam enters a preset polarized state, into a gas within a vacuum chamber; generating plasma in response to the focusing of the laser beam; magnetizing the generated plasma by inducing an electromagnetic field using a radio frequency (RF) power source mounted on the vacuum chamber and configured to provide an RF signal; and performing plasma diagnostic parameter-based monitoring based on scattered light generated via the laser beam incident into the magnetized plasma.

In accordance with another aspect of the present disclosure, there is provided a plasma diagnostic apparatus using Raman scattering, including a vacuum chamber; a gas adjustment unit configured to supply a gas into the vacuum chamber; a laser generation unit configured to generate a laser beam having a preset or higher level of energy, to control the generated laser beam so that the laser beam enters a preset polarized state, and to radiate the laser beam into the vacuum chamber; a plasma generation unit configured to generate plasma in response to the laser beam radiated into the vacuum chamber and focused on the gas; and a plasma diagnosis control unit configured to magnetize the plasma, generated by the plasma generation unit, by inducing an electromagnetic field using an RF power source, and to perform plasma diagnostic parameter-based monitoring based on scattered light generated by the laser beam incident into the magnetized plasma.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is an overall flowchart of a plasma diagnostic method using Raman scattering according to an embodiment of the present disclosure;

FIG. 2 is a diagram schematically illustrating an example of the scattering of light when a laser beam is radiated into magnetized plasma in the plasma diagnostic method using Raman scattering according to the embodiment of the present disclosure;

FIGS. 3A and 3B are diagrams illustrating an example of plasma-magnetic field intensity related theoretical and simulation results at a predetermined density in the case of Raman scattering in the plasma diagnostic method using Raman scattering the embodiment of the present disclosure;

FIG. 4 is a diagram illustrating an example of the growth rate of Raman backward scattering (RBS) that is generated in a direction opposite a direction in which the laser beam propagates when the magnetized plasma is subjected to Raman scattering at a low temperature; and

FIG. 5 is a block diagram of a plasma diagnostic apparatus using Raman scattering according to an embodiment of the present disclosure.

### DETAILED DESCRIPTION

Embodiments of the present disclosure will be described in detail below with reference to the accompanying drawings. Although specific details, such as specific components, are described in the following description, it is apparent to those skilled in the art that they are provided merely to help the general understanding of the present disclosure and various modifications and variations may be made to them without departing from the spirit and scope of the present disclosure.

The present disclosure is directed to the diagnosis of plasma. In greater detail, the present disclosure is intended to provide technology that is capable of measuring plasma diagnostic parameters (the density of plasma, the intensity and direction of the magnetic field of plasma, etc.) in such a way as to radiate a high-output laser into plasma, magnetized by an electric field induced within a chamber by a radio frequency (RF) power source, and then analyze waves, scattered through generated Raman, using preset scattering equations, thereby enabling the adaptive control of the magnetic field of plasma required for various processes.

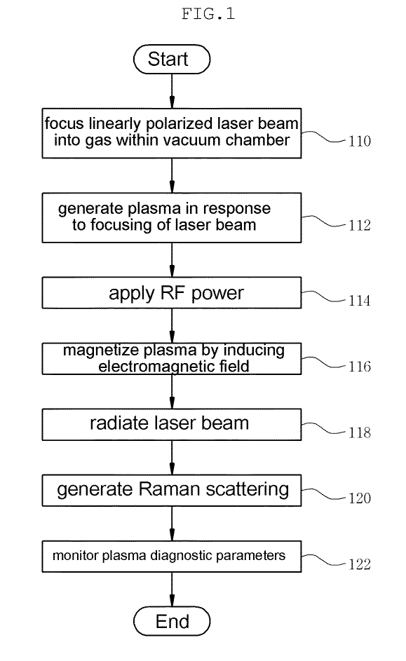

A plasma diagnostic method using Raman scattering according to an embodiment of the present disclosure will be described in detail with reference to FIG. 1.

FIG. 1 is an overall flowchart of a plasma diagnostic method using Raman scattering according to the present embodiment.

Referring to FIG. 1, in operation 110, a plasma diagnostic apparatus using Raman scattering according to an embodiment of the present disclosure focuses a laser beam, controlled so that it enters a preset polarized state, into a gas within a vacuum chamber.

In this case, the vacuum chamber provides a space for receiving a gas injected thereinto and exciting the gas into plasma, thereby providing a space for generating plasma.

The preset polarized state is a linearly polarized state that is controlled such that the laser beam is reflected in a direction perpendicular to a surface of incidence into the plasma generated within the vacuum chamber. The linearly polarized laser is focused into the gas within the vacuum chamber via a beam focusing means for focusing the laser beam, generated by the laser generation unit, into the gas within the vacuum chamber.

In operation 112, plasma is generated in response to the focusing of the laser beam.

In this case, the reactant gas is activated and transformed into the plasma by the plasma diagnostic apparatus using Raman scattering. When a high-power laser beam generated by a laser generator is radiated onto the beam focusing means, the corresponding laser beam is reflected by the beam focusing means and focused at a predetermined location within the vacuum chamber, a gas that is present at the predetermined location within the vacuum chamber and has spatially different pressures is ionized, and thus plasma is generated.

In operation 114, an RF power source having an operating frequency and providing periodic RF pulses is applied to the vacuum chamber, and in operation 116, the generated plasma is magnetized by inducing an electromagnetic field within the vacuum chamber using the applied RF power source.

In operation 118, a laser beam is radiated into the magnetized plasma, and in operation 120, Raman scattering is generated.

The laser beam incident into the magnetized plasma is a high-output laser beam having a preset or higher level of energy, and the Raman scattering has the characteristic of shifting by a plasma frequency based on the density of the plasma.

Thereafter, in operation 122, plasma diagnostic parameter-based monitoring is performed by measuring the intensity and direction of the magnetic field of the plasma and the density of the plasma from the most scattered wave for each preset period through the rotation of the laser beam linearly polarized and radiated into the magnetized plasma based on the scattered light generated by the laser beam incident into the magnetized plasma in operation 120.

In this case, the scattered light is subjected to Raman scattering that shifts by a plasma frequency based on the density of the corresponding plasma, and is perpendicular to a direction in which the incident laser beam propagates.

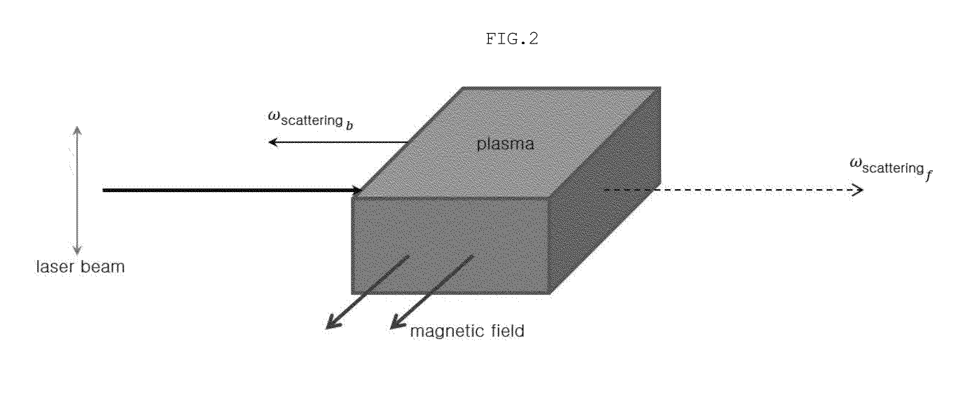

In greater detail, referring to FIG. 2, FIG. 2 is a diagram schematically illustrating an example of the scattering of light when a laser beam is radiated into magnetized plasma in the plasma diagnostic method using Raman scattering according to the present embodiment. When the structure of FIG. 2 is given, plasma scattering are expressed by Equations 1 and 2 below:

$$\begin{matrix}{ω}_{scattering f} = {ω}_{incident} \pm \sqrt{1 - \frac{1}{A} ( 1 + \frac{{ω}_{c}^{2}}{{ω}_{p}^{2}} )} & ( 1 ) \\ {ω}_{scattering b} = {ω}_{incident} - \sqrt{{ω}_{c}^{2} + {ω}_{p}^{2}} & ( 2 )\end{matrix}$$

where ωₚ is plasma frequency,

$${ω}_{c} = \frac{electron charge \times B}{electron mass} , A = \frac{1}{1 - 1 / {β}_{Φ}} , and$$

$${β}_{Φ} = \frac{velocity of laser beam in plasma}{velocity of light} .$$

When the linearly polarized laser beam is radiated into the magnetized plasma, the direction of the magnetic field is perpendicular to the linearly polarized light. The linearly polarized light of the laser beam generates the highest level of scattering when the direction of the linearly polarized light is perpendicular to the direction of the magnetic field. Accordingly, ω_{scattering f} rarely varies depending on the magnetic field, while ω_{scattering b} varies relatively sensitively depending on the magnetic field.

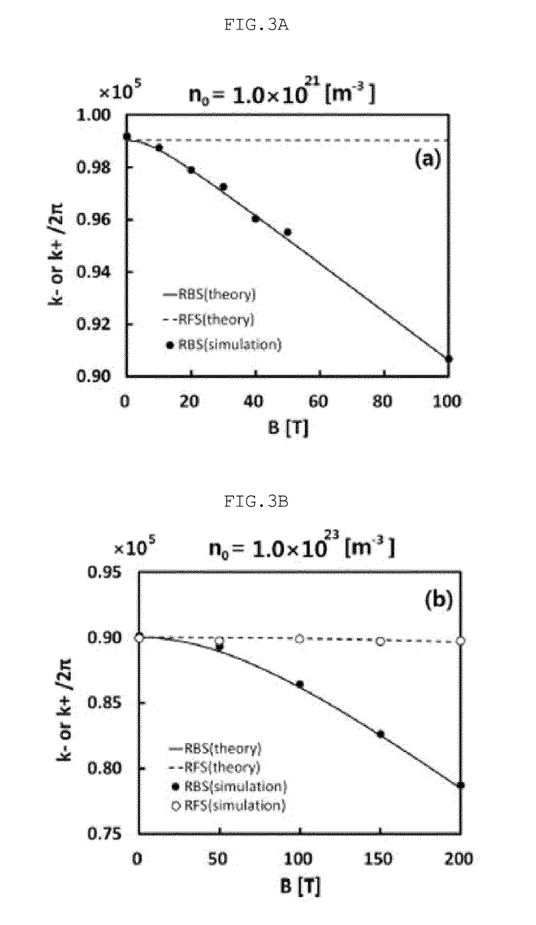

FIGS. 3A and 3B are diagrams illustrating an example of plasma-magnetic field intensity related theory and simulation results at a predetermined density in the case of Raman scattering in the plasma diagnostic method using Raman scattering according to the present embodiment. As illustrated in FIGS. 3A and 3B, the magnitude of ω_{scattering b} decreases as the intensity of the magnetic field increases, according to the theory (see C. Grebogi, phys. Fluids 23. 1330 1908), as expressed in Equation 3 below:

$$rate of increase of Raman scattering b = \frac{1}{2} {k}_{0} {V}_{0} \sqrt{\frac{{ω}_{p}^{2}}{ω incident {ω}_{h}}} \qquad ( 3 )$$

where k₀ is a wave number, V₀ is an electron velocity based on the laser beam, and ω₀=\sqrt{ωₚ²+ω_{c}²}.

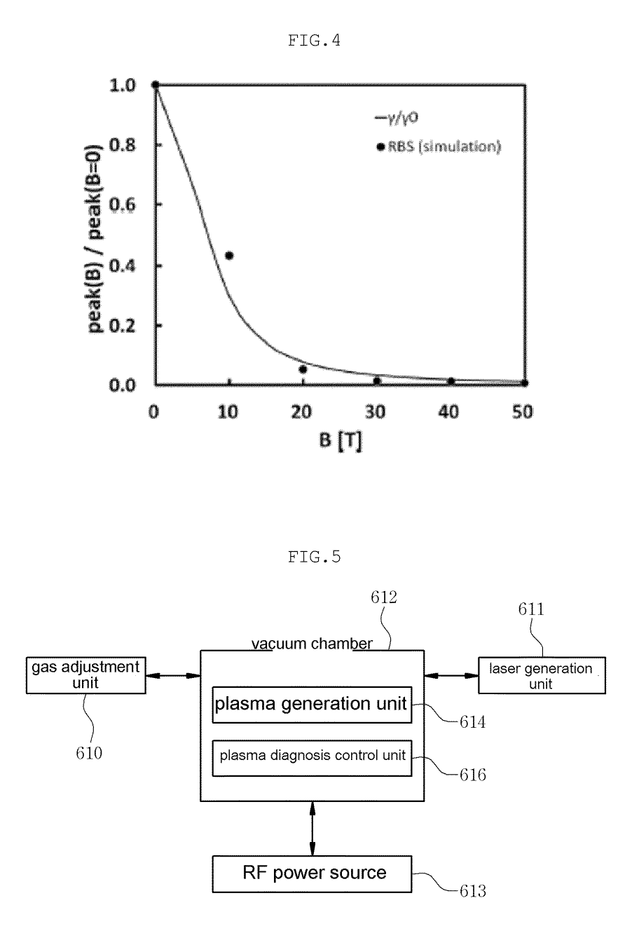

Meanwhile, FIG. 4 is a diagram illustrating an example of the growth rate of Raman backward scattering (RBS) that is generated in a direction opposite a direction in which the laser beam propagates when the magnetized plasma is subjected to Raman scattering at a low temperature. The RBS growth rate is measured based on the above-described simulation results of FIGS. 3A and 3B according to Equation 4 below:

$$γ = \frac{1}{2} {k}_{0} {v}_{0} \sqrt{\frac{{ω}_{p}^{2}}{{ω}_{c} {ω}_{h}}} \qquad ( 4 )$$

Thereafter, in the plasma diagnostic method using Raman scattering according to the present embodiment, information about the density of the plasma is determined via a wave scattered through Raman scattering in a direction in which the incident laser beam propagates when the high-output laser beam is incident into the magnetized plasma, and information about a density and a magnetic field state is determined via a wave scattered in a direction opposite the direction in which the laser beam propagates.

In this case, the linearly polarized light of the laser beam is rotated using a predetermined laser control device in order to measure the magnetic field, and the direction and intensity of the magnetic field can be measured via a wave that is most scattered when the laser light is rotated.

For a wave scattered in a direction in which the laser beam propagates (forward scattered), the direction and intensity of the magnetic field of the plasma are measured by applying Equation 5 below:

$$for forward scattered \\ {ω}_{+} = {ω}_{f} + {ω}_{0} or {ω}_{+} = {ω}_{f} - {ω}_{0} and A >> 1 , \\ {ω}_{f}^{2} \approx {ω}_{p}^{2} ( 1 - \frac{1}{A} ( 1 + \frac{{ω}_{c}^{2}}{{ω}_{p}^{2}} ) ) \qquad ( 5 )$$

For a wave scattered in a direction opposite the direction in which the laser beam propagates (backward scattered), the direction and intensity of the magnetic field of the plasma are measured by applying Equation 6 below:

for backward scattered ω_=ω_{b}−ωₕ and A<<1,

ω_{b}²≈ωₚ²+ω_{c}² (6)

In the X mode dispersion relation of Equation 7 below, the case where a plasma wave is scattered in the direction in which the laser beam propagates and the case where a plasma wave is scattered in the direction opposite the direction in which the laser beam propagates are expressed by the following Equation 8 for forward scattering (where wake field phase velocity=laser group velocity ν_{g}) and the following Equation 9 for backward scattering (wake field phase velocity), respectively, and a rearrangement equation corresponding to Equation 6 is given as Equation 10 below.

With respect to the wave scattering of the magnetized plasma according to an embodiment of the present disclosure, Equation 10 below is rearranged to an equation for the frequency ω, as in Equation 5, and the direction and intensity of the magnetic field of the plasma are measured using the resulting equation.

$$\begin{matrix}\frac{{c}^{2} {k}^{2}}{{ω}^{2}} = \frac{{c}^{2}}{{υ}_{φ}^{2}} = 1 - \frac{{ω}_{p}^{2}}{{ω}^{2}} \frac{{ω}^{2} - {ω}_{p}^{2}}{{ω}^{2} - {ω}_{h}^{2}} & ( 7 ) \\ {β}_{φ} = {β}_{g} \approx 1 - \frac{{ω}_{p}^{2}}{{ω}_{0}^{2}} & ( 8 ) \\ {β}_{φ} \approx 0 & ( 9 ) \\ \frac{{ω}^{2}}{{ω}_{p}^{2}} = \frac{1}{2} ( 1 + A + \frac{{ω}_{c}^{2}}{{ω}_{p}^{2}} ) \pm \sqrt{\frac{1}{4} ( 1 + A + \frac{{ω}_{c}^{2}}{{ω}_{p}^{2}} ) - A} \\ where A = \frac{1}{1 - 1 / {β}_{g}^{2}} & ( 10 )\end{matrix}$$

The plasma diagnostic method using Raman scattering according to the present embodiment has been described above.

A plasma diagnostic apparatus using Raman scattering according to an embodiment of the present disclosure is described with reference to FIG. 5.

FIG. 5 is a block diagram of the plasma diagnostic apparatus using Raman scattering according to the present embodiment. The plasma diagnostic apparatus using Raman scattering, to which the present disclosure has been applied, includes a gas adjustment unit 610, a laser generation unit 611, a vacuum chamber 612, and an RF power source 613.

The vacuum chamber 612 includes a plasma generation unit 614 and a plasma diagnosis control unit 616, and provides a space for receiving a gas injected thereinto and exciting the gas into plasma, thereby providing a space for generating plasma.

The gas adjustment unit 610 is mounted onto the vacuum chamber 612, and supplies a gas into the vacuum chamber 612.

The laser generation unit 611 generates a laser beam having a preset or higher level of energy, and radiates the generated laser beam into the vacuum chamber while controlling the laser beam so that it enters a preset polarized state.

In this case, the preset polarized state is a linearly polarized state that is controlled such that the laser beam is reflected in a direction perpendicular to a surface of incidence into the plasma generated in the vacuum chamber 612. The linearly polarized laser is focused into the gas within the vacuum chamber 612 via a beam focusing means (not illustrated) for focusing the laser beam, generated by the laser generation unit 611, into the gas within the vacuum chamber 612.

The laser generation unit 611 controls the linearly polarized laser so that the linearly polarized laser is reversed from a direction in which the linearly polarized laser is incident into the magnetized plasma and then propagates and is then polarized.

The plasma generation unit 614 generates plasma in response to the laser radiated into the vacuum chamber 612 and focused into the gas.

The plasma diagnosis control unit 616 magnetizes the plasma, generated by the plasma generation unit 614, by inducing an electromagnetic field using RF power, and then performs plasma diagnostic parameter-based monitoring based on the scattered light generated by the laser beam incident into the magnetized plasma.

In this case, the scattered light is subjected to Raman scattering that shifts by a plasma frequency based on the density of the corresponding plasma, and is perpendicular to a direction in which the incident laser beam propagates.

Furthermore, the plasma diagnosis control unit 616 determines information about the density of the plasma via a wave that is scattered by the Raman scattering in a direction in which the incident laser beam propagates, and also determines information about the density and the magnetic field state via a wave that is scattered in a direction opposite the direction in which the laser propagates.

Furthermore, the plasma diagnosis control unit 616 performs plasma diagnostic parameter-based monitoring by measuring the intensity and direction a plasma magnetic field and the density of the plasma from the most scattered wave for each preset period through the rotation of the laser beam linearly polarized and radiated into the magnetized plasma. In this case, a wave scattered in the incident direction of the laser beam is information that tells the density information of the plasma, while a wave scattered in the opposite direction is information that is influenced by both the density and the magnetic field. Accordingly, information about the density and the magnetic field can be acquired by analyzing two forward and backward scattered waves according to an embodiment of the present disclosure.

As described above, the plasma diagnostic method and apparatus using Raman scattering according to the present disclosure are configured and operated.

The present disclosure is advantageous in that the direction and intensity of the magnetic field of plasma and the density of plasma required for various processes are analyzed via high-sensitive waves attributable to Raman scattering, thereby enabling the adaptive control of the characteristics of the plasma.

Furthermore, the present disclosure is advantageous in those theoretical equations for the analysis of the direction and intensity of the magnetic field of plasma and the density of plasma can be derived, thereby increasing the degree of freedom of Raman scattering-based measurement.

Although the specific embodiments of the present disclosure have been disclosed for illustrative purposes, those skilled in the art will appreciate that various modifications, additions and substitutions are possible without departing from the scope and spirit of the disclosure as disclosed in the accompanying claims.

What is claimed is:

1. A plasma diagnostic method using Raman scattering, comprising:
focusing a laser beam, controlled such that the laser beam enters a preset polarized state, into a gas within a vacuum chamber;
generating plasma in response to the focusing of the laser beam;
magnetizing the generated plasma by inducing an electromagnetic field using a radio frequency (RF) power source mounted on the vacuum chamber and configured to provide an RF signal; and
performing plasma diagnostic parameter-based monitoring based on scattered light generated via the laser beam incident into the magnetized plasma.

2. The plasma diagnostic method of claim 1, wherein the preset polarized state is a linearly polarized state that is controlled such that the laser beam is incident perpendicular to a surface of incidence into the plasma generated within the vacuum chamber, and the laser beam in the linearly polarized state is incident into the magnetized plasma and then is reversed from a direction in which the laser beam propagates and then polarized.

3. The plasma diagnostic method of claim 1, wherein the laser beam incident into the magnetized plasma is a high-output laser beam having a preset or higher level of energy.

4. The plasma diagnostic method of claim 1, wherein the scattered light is subjected to Raman scattering that shifts by a plasma frequency based on the density of the corresponding plasma, and is perpendicular to a direction in which the incident laser beam propagates.

5. The plasma diagnostic method of claim 4, wherein:
information about a density of the plasma is determined via a wave scattered through Raman scattering in the direction in which the incident laser beam propagates; and
information about a density and a magnetic field state is determined via a wave scattered in a direction opposite the direction in which the laser beam propagates.

6. The plasma diagnostic method of claim 4, wherein:
for a wave scattered in the direction in which the laser beam propagates (forward scattered), a direction and intensity of the magnetic field of the plasma are measured by applying an equation below:
$$for forward scattered$$
$${ω}_{+} = {ω}_{f} + {ω}_{0} or {ω}_{+} = {ω}_{f} - {ω}_{0} and A >> 1 , \\ {ω}_{f}^{2} \approx {ω}_{p}^{2} ( 1 - \frac{1}{A} ( 1 + \frac{{ω}_{c}^{2}}{{ω}_{p}^{2}} ) ) ;$$
and
for a wave scattered in a direction opposite the direction in which the laser beam propagates (backward scattered), a direction and intensity of the magnetic field of the plasma are measured by applying an equation below:
for backward scattered ω_=ω_{b}−ωₕ and A<<1,
ω_{b}²≈ωₚ²+ω_{c}²

7. The plasma diagnostic method of claim 1, wherein performing the plasma diagnostic parameter-based monitoring is performed by measuring an intensity and direction of a magnetic field of the plasma and a density of the plasma via a most scattered wave for each preset period through rotation of the laser beam linearly polarized and radiated into the magnetized plasma.

8. A plasma diagnostic apparatus using Raman scattering, comprising:
a vacuum chamber;
a gas adjustment unit configured to supply a gas into the vacuum chamber;
a laser generation unit configured to generate a laser beam having a preset or higher level of energy, to control the generated laser beam so that the laser beam enters a preset polarized state, and to radiate the laser beam into the vacuum chamber;
a plasma generation unit configured to generate plasma in response to the laser beam radiated into the vacuum chamber and focused on the gas; and
a plasma diagnosis control unit configured to magnetize the plasma, generated by the plasma generation unit, by inducing an electromagnetic field using an RF power source, and to perform plasma diagnostic parameter-based monitoring based on scattered light generated by the laser beam incident into the magnetized plasma.

9. The plasma diagnostic apparatus of claim 8, wherein the laser generation unit controls the laser beam so that the laser beam enters a linearly polarized state that is controlled such that the laser beam is incident perpendicular to a surface of incidence into the plasma generated within the vacuum chamber, and the laser beam in the linearly polarized state is incident into the magnetized plasma and then is reversed from a direction in which the laser beam propagates and then polarized.

10. The plasma diagnostic apparatus of claim 8, wherein the scattered light is subjected to Raman scattering that shifts by a plasma frequency based on the density of the corresponding plasma, and is perpendicular to a direction in which the incident laser beam propagates.

11. The plasma diagnostic apparatus of claim 8, wherein the plasma diagnosis control unit determines:
information about a density of the plasma via a wave scattered through Raman scattering in the direction in which the incident laser beam propagates; and
information about a density and a magnetic field state via a wave scattered in a direction opposite the direction in which the laser beam propagates.

12. The plasma diagnostic apparatus of claim 11, wherein:
for a wave scattered in the direction in which the laser beam propagates (forward scattered), a direction and intensity of the magnetic field of the plasma are measured by applying an equation below:
$$for forward scattered$$
$${ω}_{+} = {ω}_{f} + {ω}_{0} or {ω}_{+} = {ω}_{f} - {ω}_{0} and A >> 1 , \\ {ω}_{f}^{2} \approx {ω}_{p}^{2} ( 1 - \frac{1}{A} ( 1 + \frac{{ω}_{c}^{2}}{{ω}_{p}^{2}} ) ) ;$$
and
for a wave scattered in a direction opposite the direction in which the laser beam propagates (backward scattered), a direction and intensity of the magnetic field of the plasma are measured by applying an equation below:
for backward scattered ω_=ω_{b}−ωₕ and A<<1,
ω_{b}²≈ωₚ²+ω_{c}²

13. The plasma diagnostic apparatus of claim 8, wherein the plasma diagnosis control unit performs the plasma diagnostic parameter-based monitoring by measuring an intensity and direction of a magnetic field of the plasma and a density of the plasma via a most scattered wave for each preset period through rotation of the laser beam linearly polarized and radiated into the magnetized plasma.
